(19) United States
(12) Patent Application Publication
(10) Pub. No.: US 2018/0160817 A1
(43) Pub. Date: Jun. 14, 2018

(54) ASSEMBLY SYSTEM USED IN SOFA BED AND A SOFA BED COMPRISING THE ASSEMBLY SYSTEM

(71) Applicant: JIAXING REST FURNITURE & APPLIANCE CO., LTD., JIAXING (CN)

(72) Inventor: JIGUAN CHEN, JIAXING (CN)

(73) Assignee: JIAXING REST FURNITURE & APPLIANCE CO., LTD., JIAXING (CN)

(21) Appl. No.: 15/671,032

(22) Filed: Aug. 7, 2017

(30) Foreign Application Priority Data
Dec. 8, 2016 (CN) 201611122926.3

(51) Int. Cl. A47C 17/14; F16B 7/18; F16B 9/02

(52) U.S. Cl. CPC A47C 17/14; F16B 9/026; F16B 7/182

(57) ABSTRACT

An assembly system used in sofa bed comprises first and second connecting rod assemblies and a member bar combination, which is composed of a plurality of member bars, each member bar is respectively connected with the first connecting rod assembly and with the second connecting rod assembly directly in a removable way. The member bars are respectively connected with the first connecting rod assembly and with the second connecting rod assembly in the form of primary-secondary rod. The assembly system allows to simply transport a frame of a sofa bed in three parts, which substantially saves the space for transportation and storage; at the same time, the three parts of the assembly system are mounted and connected very easily.

### FIELD OF THE INVENTION

The invention relates to an assembly system used in sofa bed, and also a sofa bed provided with such assembly system.

### BACKGROUND OF THE INVENTION

Sofa bed is generally composed of a frame and a soft-cover portion. In the existing market, the sofa bed is transported as a whole, or the bed frame is transported separately. During the separate transportation of frame, the frame occupies a large space, and the large free space inside the frame could not be used, so the low utility rate of space results in high transportation cost.

If all components and parts of the frame are disassembled for transportation, it will save transportation space and transportation cost, but the frame has complex structure, and the assembly is complex and only can be done by professionals, so it will increase the labor cost. Besides, it has to separately manufacture a complex linkage mechanism for each size of the overall-manufactured frame of sofa bed. The same style of sofa bed usually has different sizes to meet different needs of customers, and the common sizes include 32 inches, 44 inches, 52 inches, 60 inches, 64 inches, 68 inches, 72 inches etc. It will reduce the production efficiency, increase the production cost and at the same time bring the inventory risk when respectively manufacturing overall bed frames in so many sizes.

### SUMMARY OF THE INVENTION

In order to solve this technical problem, the invention proposes an assembly system used in sofa bed, comprising:

a first connecting rod assembly,

a second connecting rod assembly, and

a member bar combination,

Wherein the member bar combination is composed of a plurality of member bars, each member bar respectively and directly connected with the first and second connecting rod assemblies in a removable way.

Owing to this assembly system, the frame of sofa bed can be simply demounted into three parts for transportation, wherein after demounting, the first and second connecting rod assemblies respectively become general plane assembly, and all member bars can be bundled up as a member bar combination, which accordingly saves the transportation and storage space substantially; at the same time, these three parts of the assembly system can be mounted and connected very easily and can be directly connected with each other without other connection elements, which therefore avoids the problem of mismatched quantity of parts because of various parts during transportation.

The invention also includes one or more of the following features:

Furthermore, the first and second connecting rod assemblies can be connected and matched with the member bar combination in different sizes. In other words, the difference among the sofa beds of 32 inches, 44 inches, 52 inches, 60 inches, 64 inches, 68 inches, 72 inches and other sizes just lies in the different lengths of the member bar combinations, the first and second connecting rod assemblies used therein are identical, the sofa bed manufacturer may meet different customers' demands on the sofa bed of different sizes by producing only one type of the first connecting rod assembly and the second connecting rod assembly, that is the modular production of the first and second connecting rod assemblies, which improves the production efficiency. In terms of inventory, it has also to just store the connecting rod combinations of different sizes, and in case of poor market of the sofa bed of certain size, it will only cause the waste of inventory of the member bar combination matched with such size, which does not only save the storage space, but also reduces the inventory risk and the cost.

Furthermore, the member bars are respectively connected with the first connecting rod assembly and with the second connecting rod assembly in the form of primary-secondary rod.

Furthermore, the first and second connecting rod assemblies are respectively provided with multiple pairs of rotatable short bars symmetrically, each pair of short bars are respectively butted with corresponding member bars in the member bar combination, wherein one of the short bar and the corresponding member bar has a secondary end, and the other has a primary end, the inner diameter of the primary end being slightly larger than the outer diameter of the secondary end, and the secondary end can be inserted into the primary end. The connection in the form of primary-secondary rod can not only ensure the firmness of connection, but can also simplify the manufacturing technique and components and parts, and it achieves the aim of matching the member bar combinations of different sizes with the modules of the first and second connecting rod assemblies.

Preferentially, the secondary end is an 8-shaped stamping part, which is formed by stamping at one end of short bar connected with the member bar. Such processing method is convenient and efficient, and the stamping process may control the tightness degree of the matching between the primary and secondary rods. Moreover, the 8-shape may also enhance the intensity of the secondary end.

Selectively, the secondary end is connected with the short bar by welding. Wherein the outer diameter of the secondary end is slightly smaller than the outer diameter of the short bar, and the secondary end is fastened to one end of the short bar connected with the member bar, by welding. Then, the tightness degree of the matching between the primary and secondary rods can be controlled by controlling the outer diameter of the secondary end.

Selectively, the secondary end is formed by pipe-contracting at one end of the short bar connected with the member bar. Such processing method is also convenient and efficient, and the tightness degree of the matching between the primary and secondary rods can be controlled by the process of pipe- contracting.

The formation of the secondary end of the primary and secondary rods shall not be limited to the above methods.

When assembling, after the secondary end which is formed by any of above methods or other known methods is inserted into the primary end, the secondary end and the primary end may be connected by a screw or a bolt for further fastening them, so as to prevent the secondary end from falling away from the primary end.

Then, selectively, when reinforcing with the screw, the primary end is provided with a screw hole. During the process of assembling, the screw passes through the screw hole at the primary end and then is directly driven into the secondary end to achieve the connection;

Selectively, when connecting with the bolt, both the secondary end and the primary end are provided with bolt holes which are able to be aligned during the process of assembling, the bolt passes through the bolt holes at the secondary end and the primary end and then is fixed with a nut.

All of above fixing methods are easy to be achieved both by manual mounting and by automatic mounting. The way of reinforcing the secondary end and the primary end is not limited to above methods.

As another embodiment, the connecting rods can be respectively connected with the first connecting rod assembly and with the second connecting rod assembly directly by the screw.

The connection in the form of primary-secondary rod or the direct connection by the screw depends on the structure between the connecting rod assembly and the member bar, and the same assembly system may have both of the above two connection modes.

The invention also proposes a sofa bed, comprising a foldable frame and a soft-cover portion, wherein the foldable frame is formed by the assembly system. For such a sofa bed, generally, the foldable frame and soft-cover portion are respectively manufactured at two places and then are transported to another place to assemble the frame and the soft-cover portion. Therefore, the sofa bed with the assembly system can save a lot of transportation space during the process of transporting the foldable frame, which improves the transportation efficiency and reduces the transportation cost. Besides, the sofa bed can achieve the aim of obtaining the sofa beds of different sizes by merely changing the sizes of connecting rod combinations.

Therefore, the assembly system used in the sofa bed proposed by the invention can effectively solves the problems that the frame of the sofa bed occupies too large space during the transportation, the free space is unavailable, and the assembly is difficult, which saves the transportation cost and the labor cost greatly. At the same time, the assembly system used in the sofa bed proposed by the invention enables the modularization the structure of the connecting rod, which simplifies the method of changing the size of the sofa bed, reduces the inventory risk, improves the production efficiency and saves the production cost.

### BRIEF DESCRIPTION OF THE DRAWINGS

It should be understood that all features, variants and/or specific embodiments of the invention may be combined in many combinations, except the case of apparent contradiction or incompatibility.

Other advantages and features of the invention will become apparent by reading the following specific embodiments, given by way of non-limiting example, with reference to the accompany drawings, in which:

FIG. 1 shows an explosive view of an assembly system used in a two-fold sofa bed according to the invention;

FIGS. 2a and 2b respectively show a front view and a left view of a first connecting rod assembly of the assembly system used in two-fold sofa bed in FIG. 1;

FIG. 3 shows an explosive view of an assembly system used in a three-fold sofa bed according to the invention;

FIGS. 4a and 4b respectively show a front view and a top view of a first connecting rod assembly of the assembly system used in the three-fold sofa bed in FIG. 3;

FIG. 5 shows an assembly view of the assembly system used in the three-fold sofa bed in FIG. 3;

FIGS. 6a, 6b and 6c show a first embodiment of the primary and secondary rods in the assembly system according to the invention;

FIG. 7 shows a second embodiment of the primary and secondary rods in the assembly system according to the invention;

FIG. 8 shows a third embodiment of the primary and secondary rods in the assembly system according to the invention.

### DETAIL DESCRIPTION OF THE INVENTION

It should be understood that the above figures are not in real proportion, but are only the diagrams used for explaining various preferred features of the fundamental principles of the invention. The design features disclosed by the invention, for example the size, the direction, the orientation and the shape, shall be determined according to specific application and service environment.

Hereinafter, the invention will be described in detail in combination with the embodiments and the accompanying drawings. In these figures, the same reference numbers designate identical or equivalent elements of the invention in all figures.

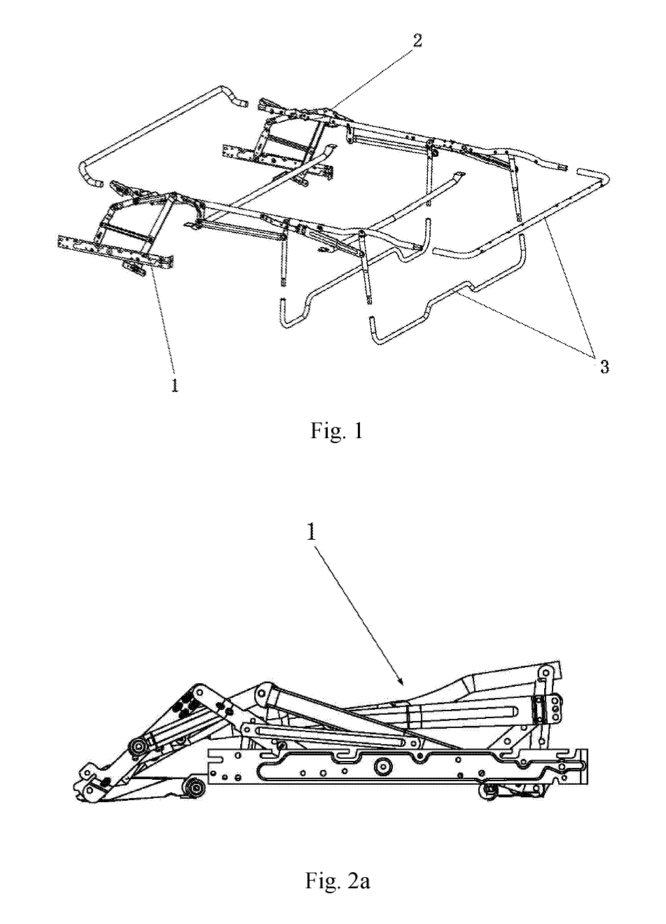

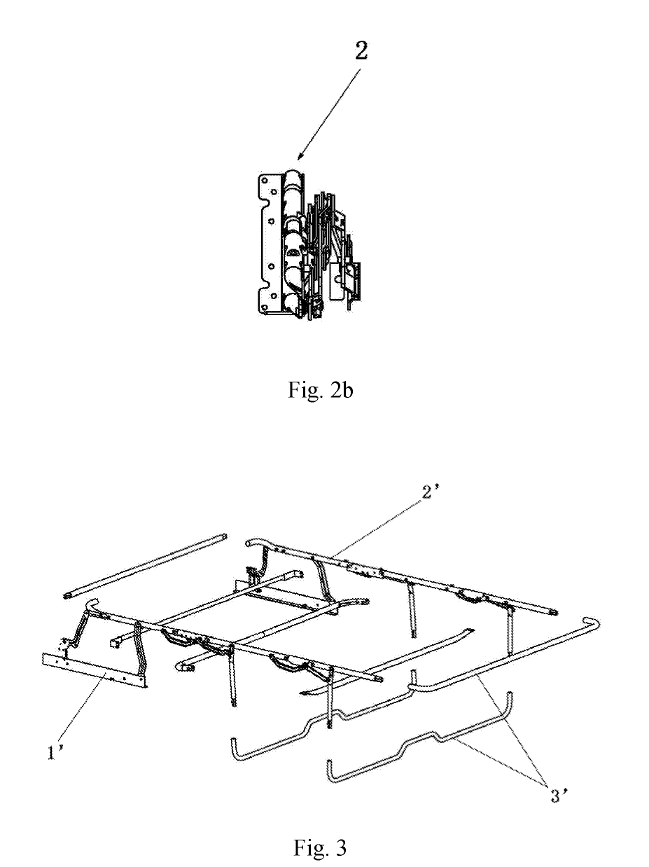

FIGS. 1, 2a and 2b show an assembly system used in a two-fold sofa bed according to the invention. As seen from the figures, the assembly system comprises:

a first connecting rod assembly 1,

a second connecting rod assembly 2, and

a member bar combination,

Wherein the member bar combination is composed of a plurality of member bars 3, each member bar is respectively and directly connected with the first connecting rod assembly 1 and the second connecting rod assembly 2 in a removable manner.

Wherein the first connecting rod assembly 1 and the second connecting rod assembly 2 are symmetric with each other.

The quantity of the member bars 3 in the member bar combination depends on the structure of the sofa bed, and the length of the member bar combination depends on the size of the sofa bed.

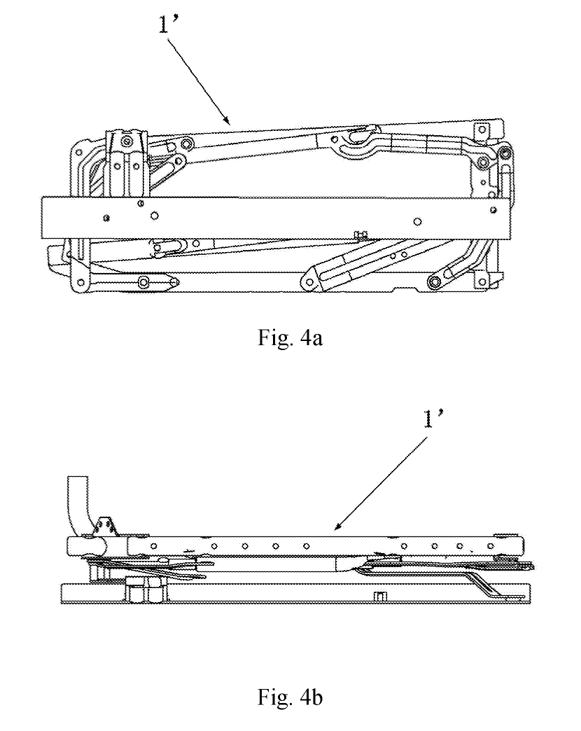

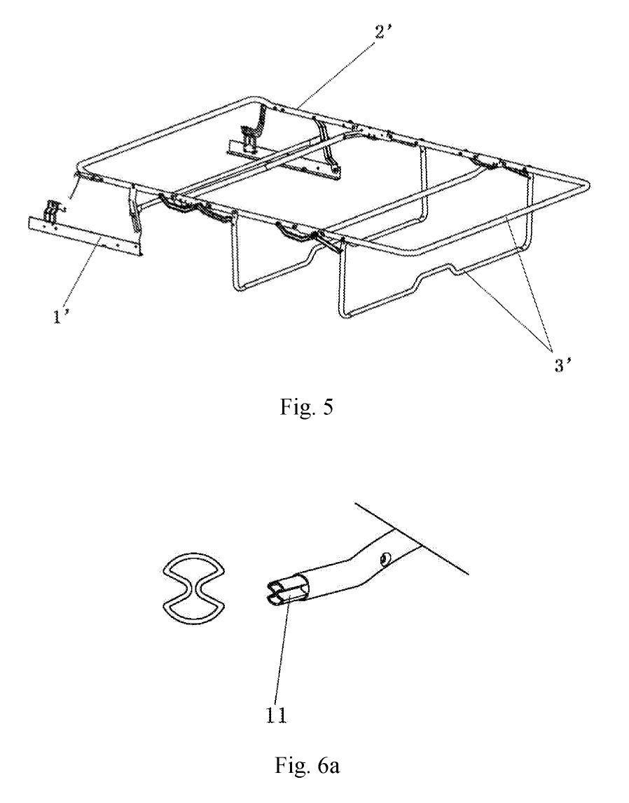

Owning to the assembly system, the frame of the sofa bed can be simply transported in three parts, wherein after demounting, the first connecting rod assembly 1 is shown in FIGS. 2a and 2b. As seen from the figures, the demounted first connecting rod assembly may be contracted to a flat shape with thin thickness, occupying less space, and nearly no free space is wasted. Wherein the second connecting rod set 2 is symmetric with the first connecting rod set 1, therefore the shape and size of the contracted second connecting rod set 2 are also symmetric with that of the first connecting rod set. Wherein all member bars 3 may be bundled together to form the member bar combination to be transported together, which eliminates the gap among the member bars and saves the transportation space to the greatest extent. FIGS. 3, 4a, 4b and 5 show an assembly system used in a three-fold sofa bed according to the invention.

As seen from the figures, the assembly system comprises:

a first connecting rod assembly 1′,

a second connecting rod assembly 2′, and

a member bar combination,

Wherein the member bar combination is composed of a plurality of member bars 3′, each member bar is respectively and directly connected with the first connecting rod assembly 1′ and with the second connecting rod assembly 2′ in a removable manner.

Wherein the first connecting rod assembly 1′ and the second connecting rod assembly 2′ are symmetric with each other.

Wherein the general structure of the assembly system used in the three-fold sofa bed is identical to that of the assembly system of the two-fold sofa bed, however wherein the specific structures and shapes of the first connecting rod assembly 1′ and of the second connecting rod assembly 2′ are different according to the different functions realized by the sofa beds, and the shapes and quantity of the member bars 3′ are also different.

Thus, it can be seen that the assembly system used in the sofa bed of the invention is suitable for the sofa bed with different structures and different functions.

Furthermore, the member bars 3, 3′ are respectively connected with the first connecting rod assembly 1, 1′ and with the second connecting rod assembly 2, 2′ in the form of primary-secondary rod.

Furthermore, the first connecting rod assembly 1, 1′ and the second connecting rod assembly 2, 2′ are respectively provided with multiple pairs of rotatable short bars symmetrically, each pair of short bars are respectively butted with corresponding member bars 3, 3′ of the member bar combination, wherein one of the short bar and the corresponding member bar 3, 3′ has the secondary end, and the other has the primary end, the inner diameter of the primary end being slightly larger than the outer diameter of the secondary end, and the secondary end being able to be inserted into the primary end.

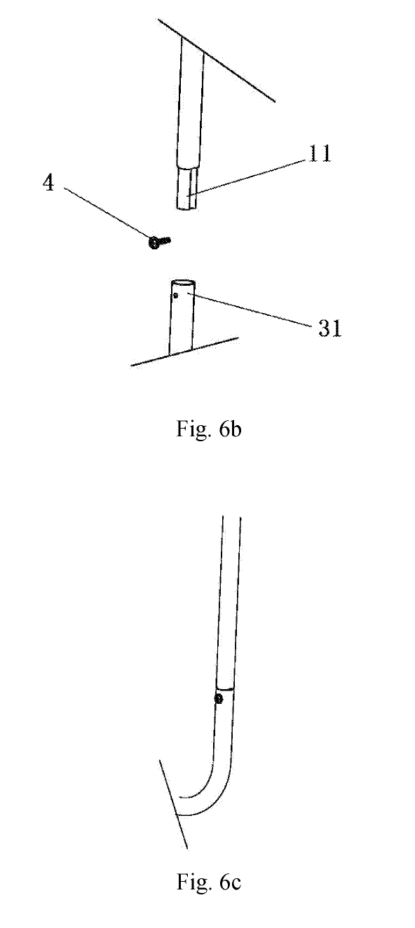

FIGS. 6a, 6b and 6c show a first embodiment of connection form of the primary and secondary rods, which is also a preferred embodiment of the invention.

As seen in the first embodiment, the short bar has the secondary end 11, the secondary end 11 has a shape of 8, the 8-shaped secondary end is formed by stamping at one end of the short bar connected with the member bar, and the forming mode is convenient and efficient. The outer diameter of the secondary end 11 is slightly smaller than other parts of the short bar, therefore the secondary end 11 has thin thickness, and the mode of stamping into 8-shape may increase the firmness of the secondary end 11. The outer diameter of the secondary end 11 may be controlled by the stamping process, and the tightness degree between the secondary end 11 and the primary end 31 can be adjusted by controlling the outer diameter of the secondary end 11. At the same time, one end of the member bar butted with the short bar has the primary end 31, the inner diameter of the primary end 31 is slightly larger than the outer diameter of the secondary end 11, and accordingly the secondary end 11 may be inserted into the primary end 31.

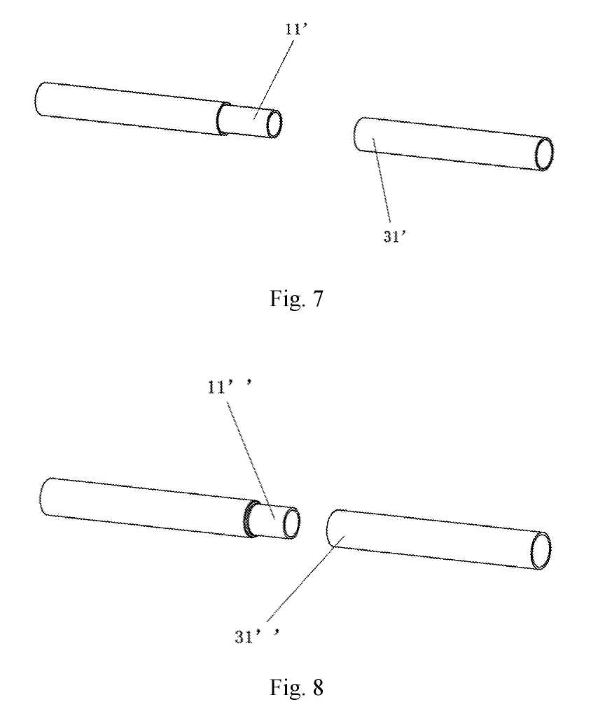

FIG. 7 shows a second embodiment of the connection form of the primary and secondary rods.

As seen in the second embodiment, the short bar has the secondary end 11′, the outer diameter of the secondary end 11′ is slightly less than the outer diameter of the short bar, and the secondary end is connected with one end of the short bar which is connected with the member bar, by welding. At the same time, one end of the member bar butted with the short bar is provided with the primary end 31′, the inner diameter of the primary end 31′ is slightly larger than the outer diameter of the secondary end 11′, and accordingly the secondary end 11′ may be inserted into the primary end 31′.

FIG. 8 shows a third embodiment of the connection form of the primary and secondary rods.

As seen in the third embodiment, the short bar has the secondary end 11″, which is formed by the pipe-contraction of one end of the short bar connected with the member bar, therefore the outer diameter of the secondary end 11″ is slightly less than the outer diameter of other parts of the short bar. At the same time, one end of the member bar butted with short bar is provided with the primary end 31″, the inner diameter of the primary end 31″ is slightly larger than the outer diameter of the secondary end 11″, and accordingly the secondary end 11″ may be inserted into the primary end 31″.

The direct connection among other member bars is not limited to the above embodiments, and the modes of other member bars are also applicable to the invention.

During the process of assembling, firstly, the member bar combination of appropriate length is selected according to the size requirement of the sofa bed; secondly, the secondary end is inserted into the primary end; finally, in order to further reinforce the connection between the secondary end and the primary end and avoid the secondary end from falling away from the primary end, Selectively, the secondary end and the primary end is connected by the screw4 or by the bolt (not shown).

When reinforcing by the screw, the primary end is further provided a screw hole (not shown). When mounting, the screw4 passes through the screw hole at the primary end and then is driven into the secondary end to realize the connection.

When reinforcing by the bolt, the secondary end and the primary end are respectively provided with bolt holes (not shown) which are able to be aligned with each other, when mounting, the bolt successively passes through the bolt holes at the secondary end and the primary end and then is fixed with nut to realize the reinforcement connection.

The reinforcement connection between the secondary end and the primary end is not limited to the above examples, and the known methods of reinforcement are all applicable to the invention.

The member bars 3, 3′ may also be directly connected and fixed to the first connecting rod assembly 1, 1′ and/or the second connecting rod assembly 2, 2′ by the screw directly.

The same assembly system may have various connection forms, that is to say that a part of member bars are able to be connected to the first connecting rod assembly and/or the second connecting rod assembly, and a part of member bars are able to be connected to the first connecting rod assembly and/or the second connecting rod assembly by the screws directly. The specific connection form depends on the shape of the member bar, for example the U-shaped member bar is suitable to be connected with the first connecting rod assembly and/or the second connecting rod assembly in the form of primary-secondary rod, and the beeline-shaped member bars is suitable to be directly connected with the first connecting rod assembly and/or the second connecting rod assembly by the screw.

The above embodiments are only used as examples, without limiting the scope of the invention. A person skilled in the art may envisage other implementations which can realize the same function, within the protection scope of the claims of the invention, on this basis. A person skilled in the art masters various embodiments, various variants and improvements. In particular, it should be cleared that the above features, variants and/or specific embodiments of the invention may be combined with each other, except the case of apparent contradiction or incompatibility. All these embodiments, variants and improvements belong to the protection scope of the invention.

What is claimed is:

1. An assembly system used in sofa bed, characterized in that the assembly system comprises:
a first connecting rod assembly (1, 1′),
a second connecting rod assembly (2, 2′), and
a member bar combination,
wherein the member bar combination is composed of a plurality of member bars (3, 3′), each member bar (3, 3′) is respectively and directly connected with the first connecting rod assembly (1, 1′) and with the second connecting rod assembly (2, 2′) in a removable manner.

2. The assembly system according to claim 1, characterized in that the member bars (3, 3′) are respectively connected with the first connecting rod assembly (1, 1′) and with the second connecting rod assembly (2, 2′) in the form of primary-secondary rod.

3. The assembly system according to claim 2, characterized in that the first connecting rod assembly (1, 1′) and the second connecting rod assembly (2, 2′) are respectively provided with multiple pairs of rotatable short bars symmetrically, each pair of short bars are respectively butted with the member bars (3, 3′) of said member bar combination, wherein one of the short bars and the member bars (3, 3′) has a secondary end, the other has a primary end, the inner diameter of the primary end is slightly larger than the outer diameter of the secondary end, and the secondary end is able to be inserted into the primary end.

4. The assembly system according to claim 3, characterized in that the secondary end (11) is an 8-shaped stamping part.

5. The assembly system according to claim 3, characterized in that the secondary end (11′) is connected with the short bars by welding, wherein the outer diameter of the secondary end (11′) is slightly smaller than the outer diameter of the short bars.

6. The assembly system according to claim 3, characterized in that the secondary end (11″) is formed by pipe-contracting at one end of the short bar connected with the member bar.

7. The assembly system according to claim 4, characterized in that after the secondary end (11, 11′, 11″) is inserted into the primary end (31, 31′, 31″), the secondary end (11, 11′, 11″) and the primary end (31, 31′, 31″) are further fastened by screw.

8. The assembly system according to claim 1, characterized in that the connecting rod (3, 3′) is respectively and directly connected with the first connecting rod assembly (1, 1′) and the second connecting rod assembly (2, 2′) by screw.

9. The assembly system according to claim 1, characterized in that the first connecting rod assembly (1, 1′) and the second connecting rod assembly (2, 2′) can be connected with the member bar combination having different sizes.

10. A sofa bed, comprising a foldable frame and a soft-cover portion, characterized in that said foldable frame is formed by the assembly system according to any one of claims 1.
